(19) United States
(12) Patent Application Publication
(10) Pub. No.: US 2007/0201194 A1
(43) Pub. Date: Aug. 30, 2007

(54) PORTABLE COMPUTER

(75) Inventors: HSUAN-CHEN CHEN, Tu-Cheng (TW); JIE ZHANG, Shenzhen (CN); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/614,989

(22) Filed: Dec. 22, 2006

(30) Foreign Application Priority Data
Feb. 25, 2006 (CN) 200620055586.2

(51) Int. Cl. G06F 1/16

(52) U.S. Cl. 361/680

(57) ABSTRACT

A portable computer includes a base unit, a cover unit, a keyboard, and a locking member. The base unit defines a receiving portion. The receiving portion defines a plurality of cutouts in two opposite sidewalls thereof. The cover unit is pivotably connected to the base unit. The keyboard is detachably mounted to the base unit. The keyboard defines a locking hole. The locking member is slidably received in the receiving portion. The locking member includes a locking portion inserted into the locking hole of the keyboard, and at least one protrusion extending from each of two opposite sides thereof for being selectively received in the cutouts of the receiving portion of the base unit.

### BACKGROUND OF THE INVENTION

1. Field of the Invention

The present invention relates to portable computers, and particularly to a portable computer readily allowing installation or removal of a keyboard thereto or therefrom.

2. Description of Related Art

A typical portable computer, such as a notebook computer, includes a base unit, and a cover unit pivotably connected to an end of the base unit. The base unit includes a top panel. The cover unit includes a display screen. Generally, a keyboard is secured to the top panel of the base unit of the notebook computer, and the position of the keyboard is non-adjustable. Users of the notebook computer are limited in how to sit when using the keyboard, which is inconvenient to users, and may cause pain or injury to the wrists and shoulders of the users.

To address aforementioned problem, an externally connected keyboard or a wireless keyboard is provided to use with the notebook computer. However, the externally connected keyboard needs an additional cable to connect with the notebook computer. When the notebook computer is being moved from one location to another, both the externally connected keyboard and the wireless keyboard detached from the notebook computer are a cumbersome burden.

What is desired, therefore, is a portable computer having a keyboard which can meet the demands of users.

### SUMMARY OF THE INVENTION

An exemplary portable computer includes a base unit, a cover unit, a keyboard, and a locking member. The base unit defines a receiving portion. The receiving portion defines a plurality of cutouts in two opposite sidewalls thereof. The cover unit is pivotably connected to the base unit. The keyboard is detachably mounted to the base unit. The keyboard defines a locking hole. The locking member is slidably received in the receiving portion. The locking member includes a locking portion inserted into the locking hole of the keyboard, and at least one protrusion extending from each of two opposite sides thereof for being selectively received in the corresponding cutouts of the receiving portion of the base unit.

Other advantages and novel features will become more apparent from the following detailed description when taken in conjunction with the accompanying drawings, in which:

### BRIEF DESCRIPTION OF THE DRAWINGS

FIG. 1 is an isometric view of a portable computer in accordance with a preferred embodiment of the present invention with a keyboard detached for use as a wireless keyboard;

FIG. 2 is an enlarged view of circled portion II of FIG. 1;

FIG. 3 is an inverted view of FIG. 1;

FIG. 4 is an enlarged view of circled portion IV of FIG. 3 where a locking member of the computer is located at an unlocked position;

FIG. 5 is an exploded view of FIG. 4, but viewed from another aspect;

FIG. 6 is an assembled view of the portable computer with the keyboard mounted therein; and

FIG. 7 is an enlarged view of circled portion VII of FIG. 6 where the locking member of the computer is located at a locked position.

### DETAILED DESCRIPTION OF THE INVENTION

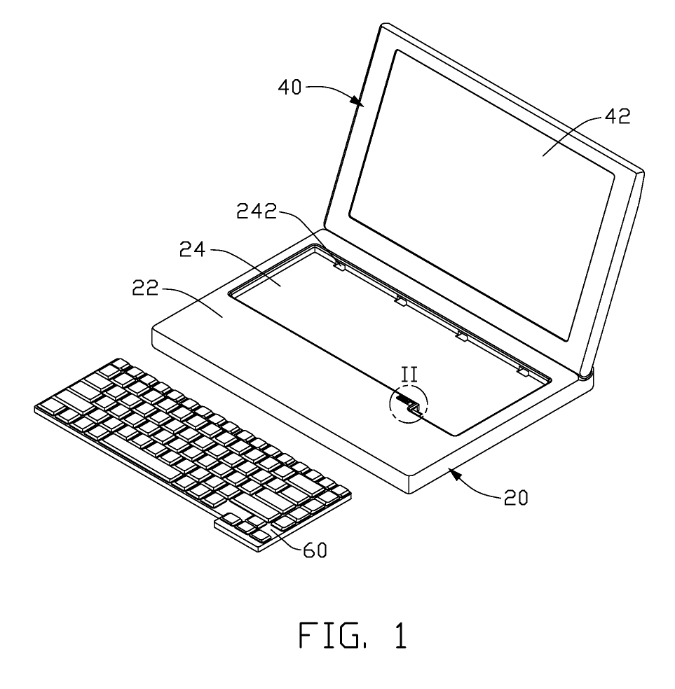

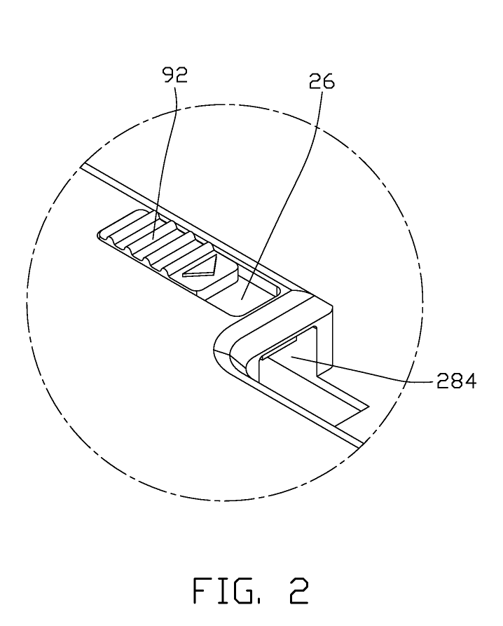

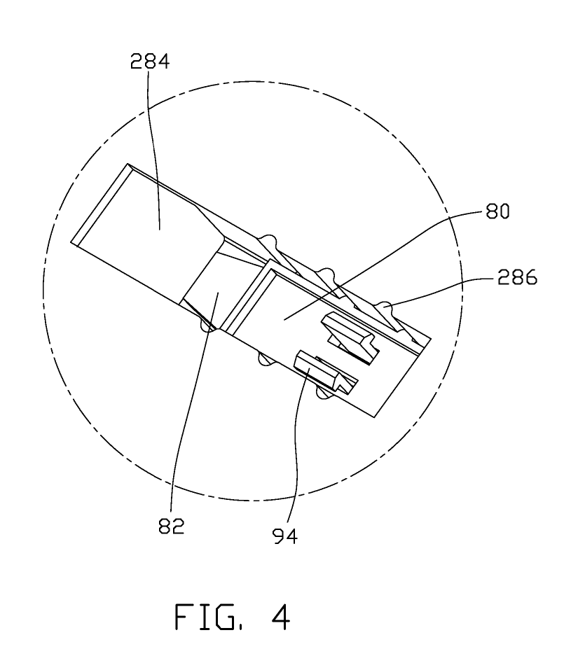

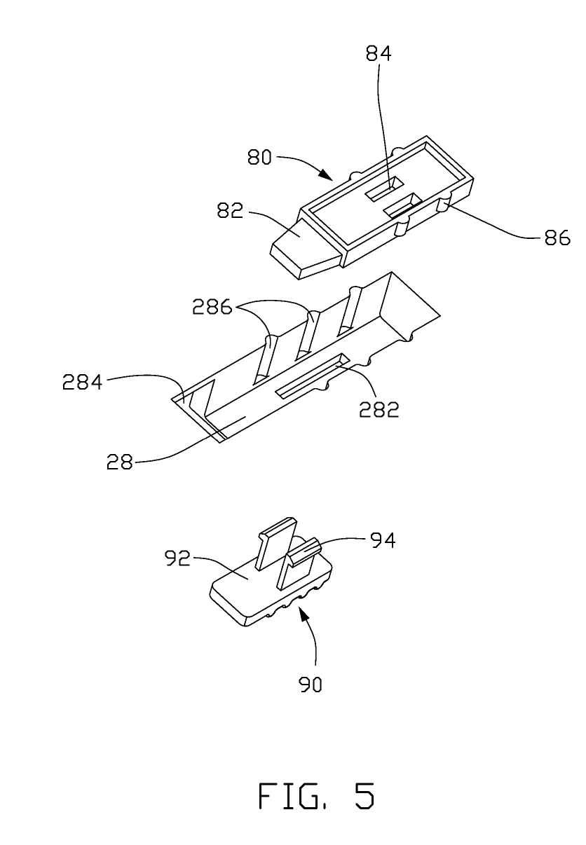

Referring to FIGS. 1 to 5, a portable computer in accordance with a first preferred embodiment of the present invention is shown. The portable computer is a notebook computer in this embodiment. The notebook computer includes a base unit 20, a cover unit 40, a keyboard 60, a locking member 80, and an operating member 90.

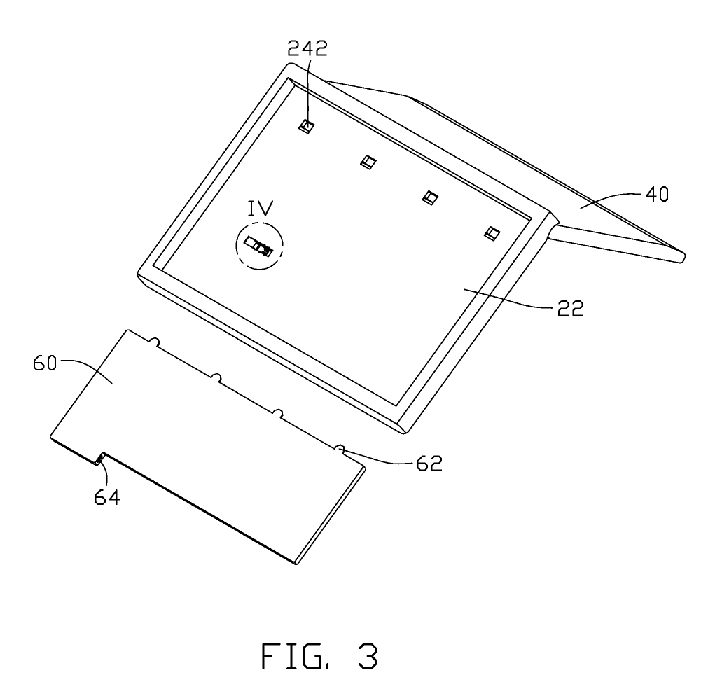

The base unit 20 includes an enclosure, a wireless communication module received in the enclosure, and a connector for connecting with a connector of the keyboard 60. The enclosure of the base unit 20 includes a rectangular top plate 22. A depressed region 24 is formed in the top plate 22, adjacent the cover unit 40. The depressed region 24 forms a plurality of receiving slots 242 in a side thereof. The top plate 22 defines a recess 26 in an outer surface thereof adjacent an opposite side of the depressed region 24. The top plate 22 defines a receiving portion 28 in an inner surface thereof, under the recess 26. The receiving portion 28 defines a receiving space. Two parallel elongated sliding slots 282 (only one shown in FIG. 3) are defined in the top plate 22 and in communication with the recess 26 and the receiving portion 28. A through hole 284 is defined in an end of the receiving portion 28 to communicate with the receiving space of the receiving portion 28 and the depressed region 24. Three parallel, spaced vertical cutouts 286 are defined in each of two opposite sidewalls of the receiving portion 28.

The cover unit 40 is pivotably connected to an end of the base unit 20. The cover unit 40 includes a display screen 42. When the notebook computer is closed, the display screen 42 is adjacent the top plate 22 of the base unit 20.

The keyboard 60 includes a wireless communication module for sending or receiving signals to or from the wireless communication module of the base unit 20, and a connector for connecting with the connector of the base unit 20. Therefore, the keyboard 60 can be used as a wireless keyboard or a typical wired keyboard, which is mounted on the base unit 20. The shape of the keyboard corresponds to the shape of the depressed region 24 of the base unit 20. A plurality of tabs 62 extends from a side of the keyboard 60, corresponding to the receiving slots 242 of the base unit 20. A locking hole 64 is defined in another side of the keyboard 60, corresponding to the through hole 284 of the top plate 22.

The locking member 80 is made of plastic or other resilient material. The locking member 80 is a rectangular plate having a locking portion 82 extending from an end thereof. The locking portion 82 is trapezium-shaped in cross-section. Two apertures 84 are defined in the locking member 80, corresponding to the sliding slots 282 of the top plate 22 of the base unit 20. Two spaced protrusions 86 extend from each of two opposite sides of the locking member 80, widths of spaces between the protrusions 86 are same as spaces between the cutouts 286 of the top plate 22.

The operation member 90 includes an operating section 92 and two clasps 94. The operating section 92 forms a plurality of ridges on a back surface thereof for facilitating manual operation. The clasps 94 extend from an opposite surface of the operating section 92.

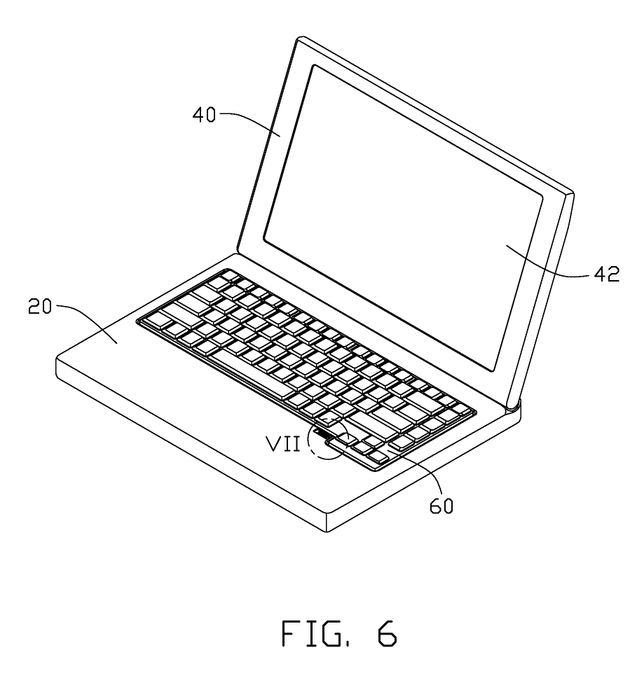

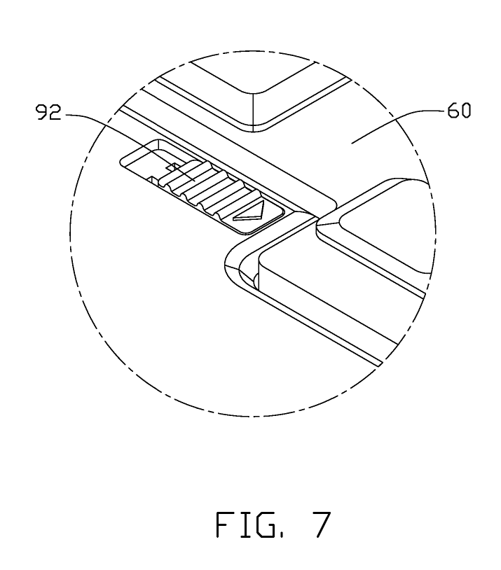

Referring to FIGS. 6 and 7, in assembling the keyboard 60, the locking member 80 is received in the receiving portion 28 of the base unit 20. The protrusions 86 of the locking member 80 are respectively received in four cutouts 286 of the receiving portion 28 away from the through hole 284 in the top plate 22 of the base unit 20. The locking portion 82 of the locking member 80 aligns with the through hole 284 of the top plate 22. The operation member 90 is received in the recess 26 of the top plate 22. The clasps 94 of the operating member 90 extend through the corresponding sliding slots 282 in the top plate 22 of the base unit 20 and the corresponding apertures 84 of the locking member 80, and engage with the locking member 80. The locking member 80 can be moved in the receiving portion 28 via moving the operation member 90 along the sliding slots 282. The tabs 62 of the keyboard 60 are received in the corresponding receiving slots 242 of the base unit 20. The keyboard 60 is pivoted about the tabs 62 until the keyboard 60 is received in the depressed region 24 of the base unit 20. The locking hole 64 in the keyboard 60 aligns with the through hole 284 in the top plate 22 of the base unit 20. The operating section 92 of the operation member 90 is pushed to slide the operation member 90 to a locked position, and the locking member 80 is driven by the operation member 90 to slide along the sliding slot 282 toward the through hole 284 of the top plate 22. The protrusions 86 of the locking member 80 are respectively received in four cutouts 286 of the receiving portion 28 near the through hole 284 in the top plate 22 of the base unit 20 for keeping the locking member 80 at the locked position. The locking portion 82 of the locking member 80 extends through the through hole 284 of the top plate 22, and is inserted into the locking hole 64 of the keyboard 60. Thus, the keyboard 60 is mounted to the top plate 22 of the base unit 20.

In detaching the keyboard 60, the operating section 92 of the operation member 90 is pushed to slide the operation member 90 to an unlocked position, and the locking member 80 is driven by the operation member 90 to slide back along the sliding slot 282. The protrusions 86 of the locking member 80 are respectively received in four cutouts 286 of the receiving portion 28 away from the through hole 284 in the top plate 22 of the base unit 20 for keeping the locking member 80 at the unlocked position. The locking portion 82 of the locking member 80 is drawn out from the locking hole 64 of the keyboard 60. Then, the keyboard 60 is detached from the top plate 22 of the base unit 20. And the keyboard 60 can be used as a wireless keyboard. The distance between the keyboard 60 and the notebook computer can be adjusted as desired.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable computer, comprising:
a base unit defining a receiving portion, the receiving portion defining a plurality of cutouts in two opposite sidewalls thereof;
a cover unit pivotably connected to the base unit;
a keyboard detachably mounted to the base unit, the keyboard defining a locking hole; and
a locking member slidably received in the receiving portion, the locking member comprising a locking portion inserted into the locking hole of the keyboard, and at least one protrusion extending from each of two opposite sides of the locking member for being selectively received in the cutouts of the receiving portion of the base unit.

2. The portable computer as claimed in claim 1, wherein the base unit comprises a top plate, the receiving portion is defined in an inner surface of the top plate, a through hole is defined in an end of the receiving portion, the locking portion of the locking member extends through the through hole of the top plate to insert into the locking hole of the keyboard.

3. The portable computer as claimed in claim 2, further comprising an operating member for driving the locking member between a locked position in which the locking portion of the locking member is inserted into the locking hole of the keyboard and an unlocked position in which the locking portion of the locking member is withdrawn from the locking hole of the keyboard.

4. The portable computer as claimed in claim 3, wherein two clasps are formed on the operating member, two sliding slots are defined in the top plate, two apertures are defined in the locking member, the clasps of the operating member extend through the corresponding sliding slots of the top plate and the corresponding apertures of the locking member, and engage with the locking member, the clasps being slidable along the sliding slots to allow the locking member sliding between the locked position and the unlocked position.

5. The portable computer as claimed in claim 4, wherein the operating member comprises an operating section forming a plurality of ridges on a back surface thereof for facilitating manual operation, the clasps extend from an opposite surface of the operating member.

6. The portable computer as claimed in claim 5, wherein a recess is defined in the top plate for receiving the operating section of the operating member.

7. The portable computer as claimed in claim 2, wherein the top plate forms a depressed region, the keyboard is received in the depressed region of the top plate, the cover unit comprises a display screen, the display screen is adjacent the top plate of the base unit when the portable computer is closed.

8. The portable computer as claimed in claim 7, wherein the keyboard forms a plurality of tabs on a side thereof, the depressed region of the base unit forms a plurality of receiving slots in a side thereof, the tabs of the keyboard are received in the corresponding receiving slots of the base unit.

9. A portable computer, comprising:
a base uni comprising a top plate, the top plate forming a depressed region;
a keyboard detachably mounted to the depressed region, the keyboard defining a locking hole;
a locking member mountable to an inner surface of the top plate of the base unit, the locking member comprising a locking portion corresponding to the locking hole of the keyboard; and
an operating member connectable to the locking member and manipulable from out of an outer surface of the top plate of the base unit for driving the locking member between a locked position in which the locking portion of the locking member is engaged in the locking hole of the keyboard and an unlocked position in which the locking portion of the locking member is disengaged from the locking hole of the keyboard.

10. The portable computer as claimed in claim 9, wherein two clasps extend from the operating member, two sliding slots are defined in the top plate, two apertures are defined in the locking member, the clasps of the operating member extend through the corresponding sliding slots of the top plate and the corresponding apertures of the locking member, and engage with the locking member.

11. The portable computer as claimed in claim 10, wherein the top plate defines a through hole, the locking portion of the locking member extends through the through hole of the top plate before being inserted into the locking hole of the keyboard.

12. The portable computer as claimed in claim 11, wherein a receiving portion is defined in the inner surface of the top plate for receiving the locking member, a plurality of cutouts are defined in two opposite sidewalls of the receiving portion, at least one protrusion extending from each of two opposite sides of the locking member for being selectively received in the cutouts of the receiving portion of the top plate corresponding to the locking member is in a locked position or an unlocked position.

13. The portable computer as claimed in claim 9, wherein the keyboard forms a plurality of tabs on a side thereof, the depressed region of the base unit forms a plurality of receiving slots on a corresponding side thereof, the tabs of the keyboard are received in the corresponding receiving slots of the base unit.

14. The portable computer as claimed in claim 9, further comprising a cover unit, wherein the cover unit comprises a display screen, the display screen is adjacent the top plate of the base unit when the portable computer is closed.

15. A portable computer, comprising:
a base unit comprising a top plate comprising a depressed region and a receiving space formed under the top plate and communicating with the depressed region;
a keyboard detachably mounted to the depressed region;
a locking member slidably mounted in the receiving space, the locking member comprising a locking portion engagable with the keyboard;
an operating member slidably attached to the top plate and engaged with the locking member, the operating member being manipulable from an outside of the top plate and slidable along the top plate for driving the locking member to slide between a locked position in which the locking portion is engaged with the keyboard and an unlocked position in which the locking portion is disengaged from the keyboard; and
a display pivoted to the base unit.

16. The portable computer as claimed in claim 15, wherein the top plate defines an elongated slot above the receiving space, the locking member defines an aperture, and the operating member comprises a clasp extending through the elongated sot to engage with the locking member in the aperture, the clasp together with the locking member being slidable along the elongated slot.

17. The portable computer as claimed in claim 16, wherein the keyboard defines a locking hole facing and communicating with the receiving space, the locking portion is inserted into the locking hole when the locking member is in the locked position and withdrawn from the locking hole when the locking member is in the unlocked position.

18. The portable computer as claimed in claim 16, wherein a recess is defined in an outer surface of the top plate communicating with the elongated slot, and the operating member further comprises an operating section slidably received in the recess, the clasping extending downward from the operating section and then through the elongated slot.

19. The portable computer as claimed in claim 16, wherein one of the top plate and the locking member defines cutouts, and the other of the top plate and the locking member forms at least one protrusion selectively received in one of the cutouts when the locking member is in the locked position and selectively received in another one of the cutouts when the locking member is in the unlocked position.

20. The portable computer as claimed in claim 16, wherein the keyboard comprises a wireless communication module for sending or receiving signals to or from another wireless communication module installed within the base unit.
